(19) United States
(12) Patent Application Publication
(10) Pub. No.: US 2015/0351367 A1
(43) Pub. Date: Dec. 10, 2015

(54) Modular furniture system for cats

(71) Applicant: Papercut Lab Corp., Milpitas, CA (US)

(72) Inventor: Jeff Lin, Milpitas, CA (US)

(21) Appl. No.: 14/718,880

(22) Filed: May 21, 2015

Related U.S. Application Data
(60) Provisional application No. 62/008,724, filed on Jun. 6, 2014.

(51) Int. Cl. A01K 15/02

(52) U.S. Cl. CPC A01K 15/024; A01K 15/02

(57) ABSTRACT

A modular furniture system for use with cats includes shaped components and component connectors, to allow assembly in a configuration. The shaped components can be polygon shaped with right angles between segments, and flat rectangular side surfaces. The shaped components can be i-shaped, z-shaped, t-shaped, square-shaped, and l-shaped, can be manufactured from corrugated cardboard sheets that are glued together, and can further include a cover. Sides of the shaped components can be impregnated with a catnip solution to attract cats, which can use the modular furniture system for play and to scratch their claws.

### CROSS-REFERENCE TO RELATED APPLICATIONS

This application claims benefit of U.S. Provisional Application No. 62/008,724, filed Jun. 6, 2014.

### FIELD OF THE INVENTION

The present invention relates generally to the field of modular furniture systems, and more particularly to methods and systems for modular furniture systems made of cardboard for use by cats.

### BACKGROUND OF THE INVENTION

Cats and other pets tend to scratch various surfaces in order to remove debris or other material from their claws. This however, can damage and ruin furniture, wooden floors, carpets, beds, and other items in the home, which can be quite costly or impractical to repair and/or replace. Further, it can be difficult to find unique storage pieces for a home that are both suitable for homeowners, who have pets, and for display of decorative items.

Devices are known that relate to shelving units, wherein one device provides a shelving unit having a plurality of box-shaped sections that are stackable in a stepwise manner. Other devices relate to stackable trays with a plurality of vertically stackable tray units. However, these existing devices do not utilize a plurality of shelving unit shapes that can include I, Z, T, L, and square shapes.

As such, considering the foregoing, it may be appreciated that there continues to be a need for novel and improved devices and methods for stackable and modular furniture that is suitable for use with cats.

### SUMMARY OF THE INVENTION

The foregoing needs are met, to a great extent, by the present invention, wherein in aspects of this invention, enhancements are provided to the existing model of modular furniture that are suitable for use by cats to play and scratch their nails.

In an aspect, a modular furniture system for use with cats can include a plurality of shaped components, such that the shaped components are shaped with rectangular shapes and right angles, such that the shaped components are hollow from front to rear, and have flat rectangular side surfaces that allow the components to be stacked and positioned side by side.

In a related aspect, the modular furniture system can further include component connectors that can connect two adjacent shaped components.

In a related aspect, the shaped components can be made from corrugated cardboard sheets that are glued together.

In a further related aspect, the corrugated cardboard sheets can have a thickness of 3 mm.

In another related aspect, sides of the shaped components can be impregnated with a catnip oil solution.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a modular furniture system in use, according to an embodiment of the invention.

FIG. 2 is a front perspective view of an i-shaped component of the modular furniture system, according to an embodiment of the invention.

FIG. 3 is a front perspective view of a z-shaped component of the modular cat furniture system, according to an embodiment of the invention.

FIG. 4 is a front perspective view of a t-shaped component of the modular cat furniture system, according to an embodiment of the invention.

FIG. 5 is a front perspective view of a square-shaped component of the modular cat furniture system, according to an embodiment of the invention.

FIG. 6 is a front perspective view of an l-shaped component of the modular cat furniture system, according to an embodiment of the invention.

FIG. 7 is a side perspective view of an l-shaped component of the modular cat furniture system, according to an embodiment of the invention.

FIG. 8 is a perspective view of a component connector of the modular cat furniture system, according to an embodiment of the invention.

FIG. 9 is a perspective view of a single corrugated cardboard sheet that is a part of a shaped component of the modular furniture system, according to an embodiment of the invention.

FIG. 10 is a perspective view of a cover that is a part of a shaped component of the modular furniture system, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

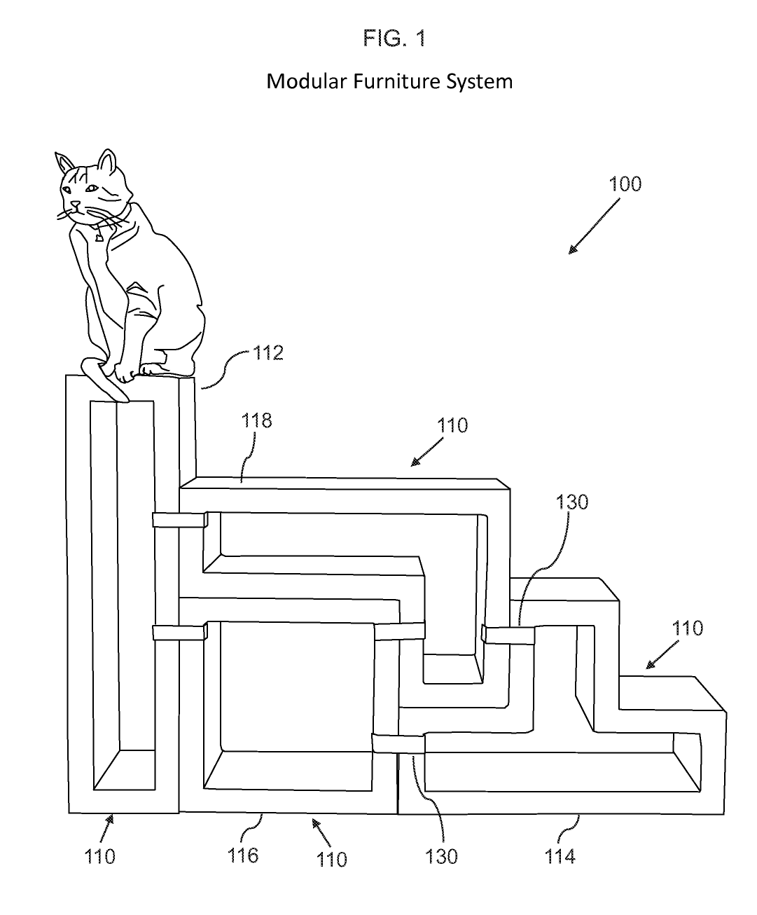

In the following, we describe the structure of an embodiment of a modular furniture system 100 for use with cats a modular furniture system for use with cats 100 with reference to FIG. 1, in such manner that like reference numerals refer to like components throughout; a convention that we shall employ for the remainder of this specification.

In an embodiment, a modular furniture system 100 for use with cats can include at least one shaped component 110.

In a related embodiment, the shaped component 110 can be selected from the group consisting of:
i. an i-shaped component 112, as shown in FIG. 3;
ii. a z-shaped component 113;
iii. a t-shaped component 114;
iv. a square-shaped component 116;
v. an l-shaped component 118;

In an embodiment, a modular furniture system for use with cats 100 can include:
a. a plurality of shaped components 110;
b. a plurality of component connectors 130;
Wherein the components are assembled in a configuration such that at least one side of any first shaped components is positioned

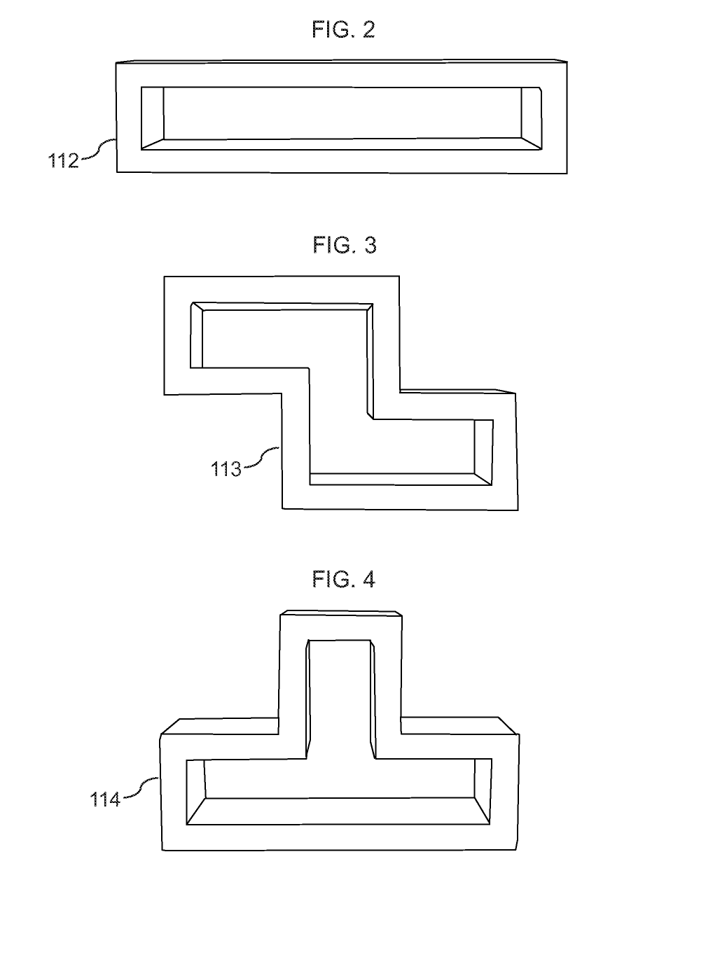

In a related embodiment, FIG. 2 shows a front perspective view of an i-shaped component 112.

In a related embodiment, FIG. 3 shows a front perspective view of a z-shaped component 113.

In a related embodiment, FIG. 4 shows a front perspective view of a t-shaped component 114.

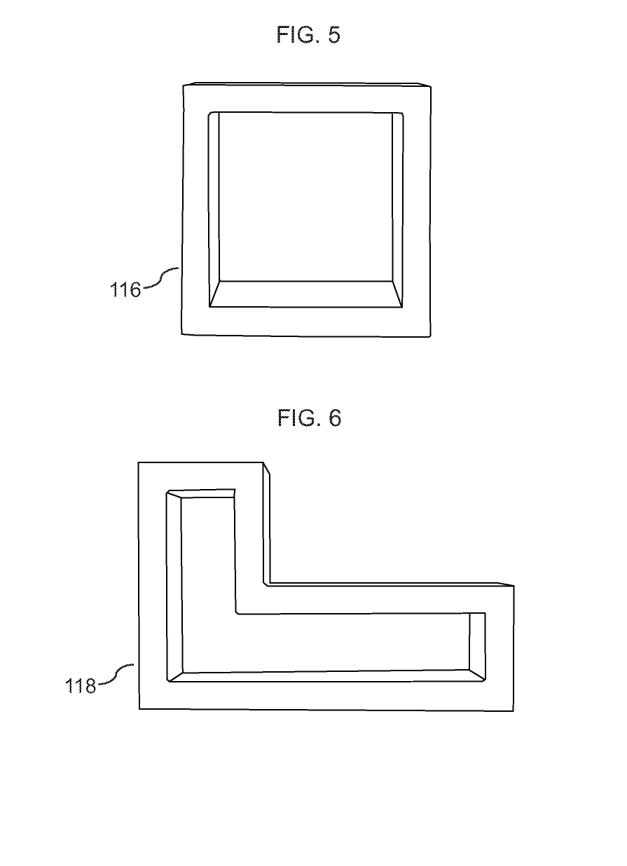

In a related embodiment, FIG. 5 shows a front perspective view of a square-shaped component 116.

In a related embodiment, FIG. 6 shows a front perspective view of an l-shaped component 118.

In a related embodiment, the modular furniture system 100 provides a large shelving and/or storage unit that can be utilized as a cat tree or cat scratching post.

In a related embodiment, the modular furniture system 100 includes hollow shaped components 110 that can rest in a stable position on the floor, wherein the modular furniture system 100 includes a plurality of geometric shapes that are assembled to form one unitary body.

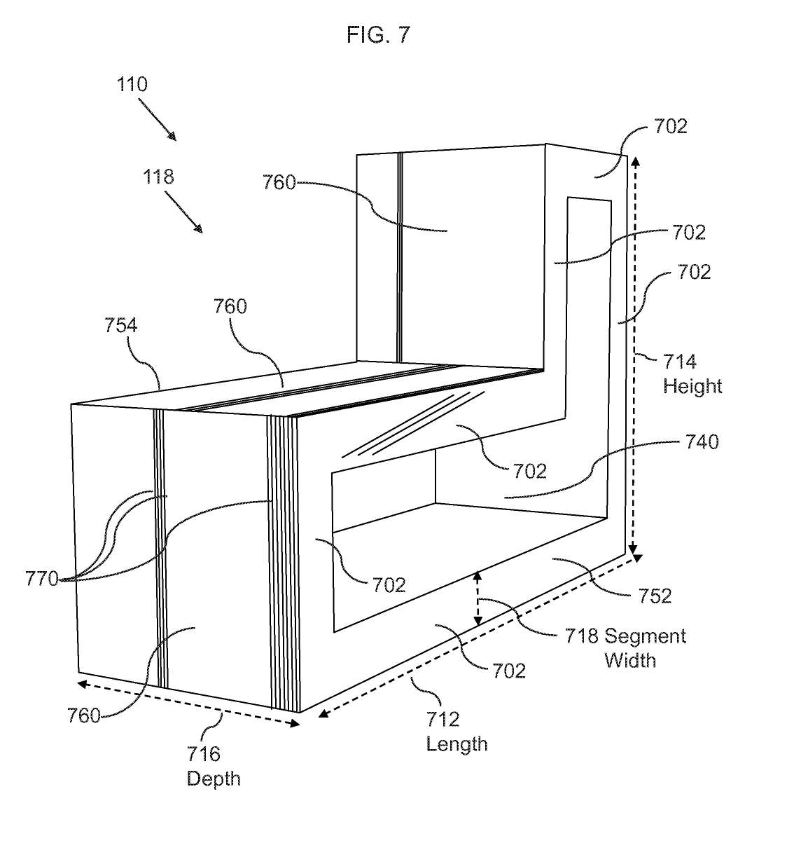

In a related embodiment, a shaped component 110, such as for example the l-shaped component 118, as shown in FIG. 7, can be polygon shaped with straight segments 702 of uniform segment width 718, and right angles between segments 702, and a uniform depth 716, such that the polygon shape is closed and has an interior aperture 740 from a first facade 752 to a second facade 754 (not directly visible in FIG. 7), which is on the opposing side to the first facade 752. The shaped component 110 thereby has a plurality of outer sides 760, which are flat rectangular surfaces, with depth equal to the depth of the shaped component and length equal to the length of the corresponding segment. FIG. 7 further illustrates the length 712 and the height 714 of the shaped component 110. It should be noted that the length 712 and the height 714 could be considered relative, according to the positioning of an outer side 760 of the shaped component 110 on a surface.

In a related example embodiment, the i-shaped component 112 can have length 712×height 714×depth 716 dimensions of 32″×8″×8″.

In a related example embodiment, the a z-shaped component 113 can have length 712×height 714×depth 716 dimensions of 24″×16″×8″.

In a related example embodiment, the t-shaped component 114 can have length 712×height 714×depth 716 dimensions of 24″×16″×8″.

In a related example embodiment, the square-shaped component 116 can have length 712×height 714×depth 716 dimensions of 16″×16″×8″.

In a related example embodiment, the l-shaped component 118 can have length 712×height 714×depth 716 dimensions of 24″×16″×8″.

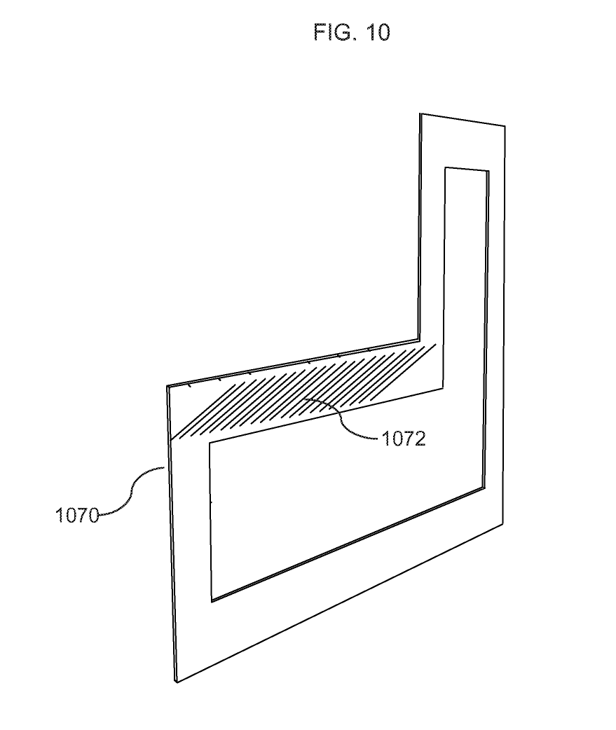

In a related embodiment, as further shown in FIG. 7, a shaped component 110 can be manufactured from a plurality of corrugated cardboard sheets 770, also known as corrugated fiberboards, which are glued together with an adhesive, such that each corrugated cardboard sheet 770 is a part of the shaped component 110 in the cross-sectional plane of depth 716, whereby the plurality of corrugated cardboard sheets 770 build up the depth 716 of the shaped component 110. FIG. 9 shows a single corrugated card board sheet 770.

In a further related embodiment, the corrugated cardboard sheets 770 can be B flute corrugated cardboard with a thickness of 3 mm, such that each shaped component 110 can be assembled with 67 corrugated cardboard sheets 770, with a tolerance/variation of +/−2 sheets 770. The thickness can vary according to preference and can be thicker or thinner than 3 mm. Similarly different types of corrugated cardboard sheets 770 can be used.

In a related embodiment, the modular furniture system 100 can further include a catnip bag or pouch, which can contain a mixture or material containing catnip. The inside material can for example be catnip leaves or a fiber material containing catnip. The catnip bag can then be placed on a shaped component 110, whereby the catnip bag can attract cats to the modular furniture system 100.

In a related embodiment, a shaped component 110 can be impregnated on the outer sides 760, with a catnip solution, which can include:
a. a water based solution containing an extract of catnip;
b. a water based solution containing Nepetalacone;
c. an oil based solution containing an extract of catnip;
d. a catnip essential oil solution, also known as an essential oil of Nepeta cataria; or
e. an oil solution containing Nepetalacone, an isolate of catnip, which acts as a cat attractant;
such that the catnip solution for example can be sprayed on the outer sides 760 of the shaped component 110 during manufacturing of the shaped component 110.

In a related embodiment, the modular furniture system 100 provides a plurality of individual storage spaces and/or display areas wherein a user can store plants, vases, shoes, books, decorative décor, and similar items.

In a related embodiment, a shaped component 110 can be constructed from cardboard, wood, plastic, or other suitable material.

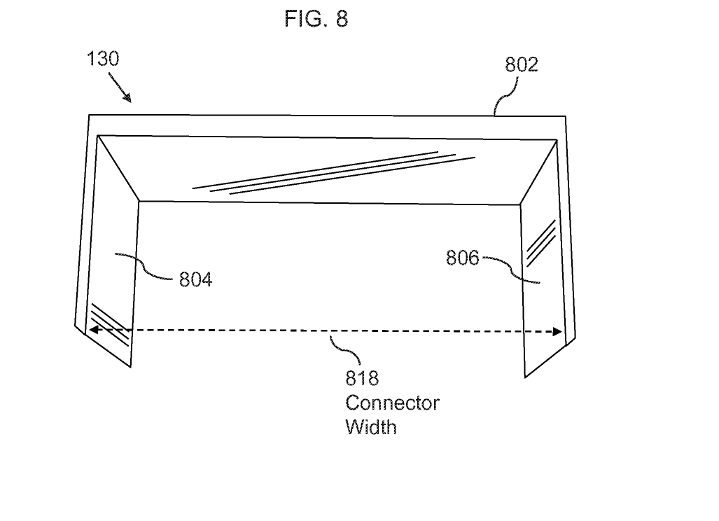

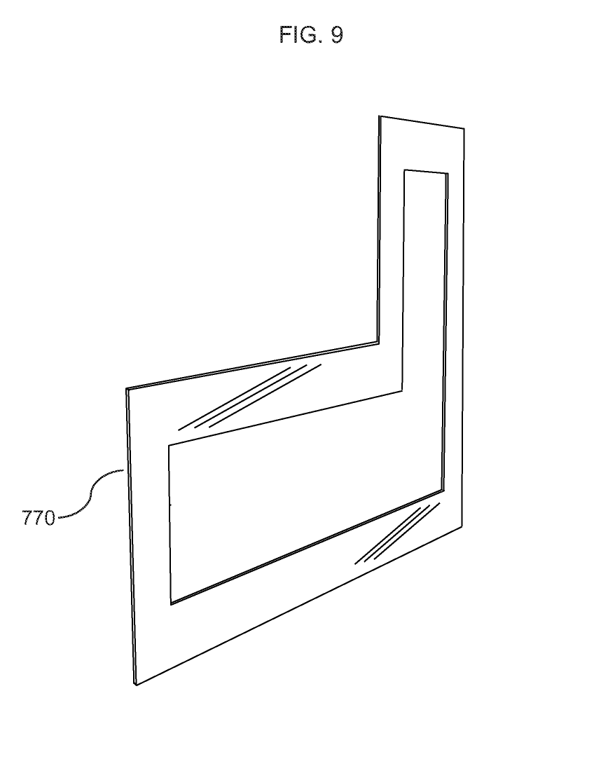

In a related embodiment, FIG. 8 shows a component connector 130, further comprising:
a. a front bridge 802;
b. first and second side clips 804, 806, which are perpendicularly connected to first and second ends of the front bridge 802;
wherein the component connector is configured with a connector width 818 between inner sides of the first and second side clips 804, 806 that is twice the segment width 718 of shaped component 110, such that the side clips 804, 806 can clip around and connect two adjacent shaped components 110.

In a related embodiment, the component connector 130 can be made of a flexible material, such as plastic. The plastic material can for example be biodegradable PLA plastic.

In a related embodiment, the modular furniture system 100 can further be utilized as a cat jungle gym or cat scratching device by covering the shaped component 110 in a rough material to provide a suitable area for cats to scratch thereon.

In a related embodiment, the modular furniture system 100 can further operate as a book shell, coffee table, shoe rack, and the like.

In a related embodiment, the shaped components 110 can be made from corrugated cardboard, fiberboards, or other durable and long-lasting materials that can be bonded via the use of a non-toxic starch based adhesive or other suitable adhesive.

In a related embodiment, the modular furniture system 100 can prevent cats from scratching and ruining a user's furniture, floors, carpet, beds, and related items in the home. Further, the modular furniture system 100 can help to entertain a cat or other pets, and can function as a toy or play area for pets.

In a related embodiment, the modular furniture system 100 can be employed for general domestic or commercial use, and can be especially useful for pet owners, animal shelters, veterinarian offices, and the like.

In a related embodiment, the modular furniture system 100 can be utilized as a decorative fashion statement for the home, while providing a storage and display space for various items.

In a related embodiment, as shown in FIG. 10, a shaped component 110 can further include a cover 1070, which can be a piece shaped and sized like a corrugated cardboard sheet 770, such that the cover 1070 is attached, for example with adhesive, to a first or second facade 752, 754 of a shaped component 110, such that the cover 1070 provides an aesthetically pleasing surface 1072, which can for example be a white, black, colored, plastic, or wood laminated surface.

Here has thus been described a multitude of embodiments of the modular furniture system 100 for use with cats, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A modular furniture system for use with cats, comprising:
a plurality of shaped components;
wherein each shaped component in the plurality of shaped components is polygon shaped with straight segments of uniform width, and right angles between segments, and a uniform depth, such that a polygon shape of each shaped component is closed, such that each shaped component has an interior individual aperture from a first individual facade to a second individual facade, which is on an opposing side to the first individual facade, such that each shaped component has a plurality of outer individual sides, which are flat rectangular surfaces;
wherein the shaped components are assembled in a configuration such that at least one side of any first shaped components is positioned adjacent to a side of a second shaped component.

2. The modular furniture system of claim 1, wherein each shaped component is selected from the group consisting of an i-shaped component, a z-shaped component, a t-shaped component, a square-shaped component, and an l-shaped component.

3. The modular furniture system of claim 1, further comprising:
at least one component connector;
wherein at least two shaped components in the plurality of shaped components are positioned adjacent to each other, such that the two shaped components are connected with the component connector.

4. The modular furniture system of claim 1, wherein the shaped components are each manufactured from a plurality of corrugated cardboard sheets, which are glued together with an adhesive, such that each corrugated cardboard sheet is a part of a shaped component in a cross-sectional plane of depth.

5. The modular furniture system of claim 4, wherein the corrugated cardboard sheets are 3 mm thick, such that each shaped component is assembled from 67 sheets with a variation of +/−2 sheets.

6. The modular furniture system of claim 4, wherein at least one outer side, of at least one shaped component in the plurality of shaped components, is impregnated with a catnip solution.

7. The modular furniture system of claim 6, wherein the catnip solution is selected from the group consisting of:
a) a water based solution containing an extract of catnip;
b) a water based solution containing nepetalacone;
c) an oil based solution containing an extract of catnip;
d) an essential oil of nepeta cataria; and
e) an oil based solution containing nepetalacone.

8. The modular furniture system of claim 4, wherein the component connector further comprises:
a) a front bridge; and
b) first and second side clips, which are perpendicularly connected to first and second ends of the front bridge;
wherein the component connector is configured with a connector width between inner sides of the first and second side clips that is twice a segment width of the two shaped components, such that the side clips clip around and connect the two shaped components.

9. The modular furniture system of claim 1, wherein at least one shaped component, in the plurality of shaped components, further comprises a cover, such that the cover is attached to a facade of the at least one shaped component.

10. A modular furniture system for use with cats, comprising:
at least one shaped component;
wherein the at least one shaped component is polygon shaped with straight segments of uniform width, and right angles between segments, and a uniform depth, such that a polygon shape of the at least one shaped component is closed, such that the at least one shaped component has an interior aperture from a first facade to a second facade, which is on an opposing side to the first facade, such that the shaped component has a plurality of outer sides, which are flat rectangular surfaces.

11. The modular furniture system of claim 10, wherein the at least one shaped component is selected from the group consisting of an i-shaped component, a z-shaped component, a t-shaped component, a square-shaped component, and an l-shaped component.

12. The modular furniture system of claim 10, further comprising:
a) at least two shaped components, one of which is the at least one shaped component; and
b) at least one component connector;
wherein the at least two shaped components are positioned adjacent to each other, such that the at least two shaped components are connected with the component connector.

13. The modular furniture system of claim 10, wherein the at least one shaped component is manufactured from a plurality of corrugated cardboard sheets, which are glued together with an adhesive, such that each corrugated cardboard sheet is a part of the at least one shaped component in a cross-sectional plane of depth.

14. The modular furniture system of claim 13, wherein the corrugated cardboard sheets are 3 mm thick, such that each shaped component is assembled from 67 sheets with a variation of +/−2 sheets.

15. The modular furniture system of claim 10, wherein at least one outer side of the at least one shaped component is impregnated with a catnip solution.

16. The modular furniture system of claim 15, wherein the catnip solution is selected from the group consisting of:
a) a water based solution containing an extract of catnip;
b) a water based solution containing nepetalacone;
c) an oil based solution containing an extract of catnip;
d) an essential oil of nepeta cataria; and
e) an oil based solution containing nepetalacone.

17. The modular furniture system of claim 12, wherein the component connector further comprises:
a) a front bridge; and
b) first and second side clips, which are perpendicularly connected to first and second ends of the front bridge;
wherein the component connector is configured with a connector width between inner sides of the first and second side clips that is twice a segment width of the two shaped components, such that the side clips clip around and connect the two shaped components.

18. The modular furniture system of claim 10, wherein the at least one shaped component further comprises a cover, such that the cover is attached to a facade of the at least one shaped component.
